(19) United States
(12) Patent Application Publication
(10) Pub. No.: US 2010/0171975 A1
(43) Pub. Date: Jul. 8, 2010

(54) Focus Image Centering and Printing on a Specified Paper Size

(75) Inventor: Alimin Purnomo, Fremont, CA (US)

Correspondence Address: BUCHANAN, INGERSOLL & ROONEY PC, POST OFFICE BOX 1404, ALEXANDRIA, VA, 22313-1404, US

(73) Assignee: KONICA MINOLTA SYSTEMS LABORATORY, INC., Huntington Beach, CA (US)

(21) Appl. No.: 12/348,829

(22) Filed: Jan. 5, 2009

(51) Int. Cl. G06F 3/12

(52) U.S. Cl. 358/1.15

(57) ABSTRACT

A printing system, which includes a printer and a client computer having executable instructions for creating a print job for producing a large format of an image. The executable instructions include selecting a medium size, displaying an image on a display associated with the client computer, wherein the image is partitioned into a plurality of images, selecting a partition within the plurality of images, and printing the selected partition.

### FIELD OF THE INVENTION

This invention relates to printing of large format printouts (poster printing), and in particular, it relates to network printer system and method for creating a print job for printing a large format printout of an image which is partitioned into a plurality of images by selecting a partition using an image focal point within the plurality of images, and printing the selected partition.

### BACKGROUND OF THE INVENTION

Poster printing refers to large format printing where the printouts have sizes many times larger than a letter or A4 sized sheet. For example, a poster may be 36 inches by 24 inches in size. In addition, high quality printouts are desired for poster printing. Conventionally, posters are printed on large format papers and require sophisticated, large printers to print. Small printers, i.e., printers typically used in homes or business offices, are typically limited to letter, legal, A4 and A3 sizes papers and cannot handle larger sized papers.

To enable printing of a large format poster using a small printer in an inexpensive manner, some printer drivers or application software provide a poster printing function, which divides the large poster image into smaller image sections, typically rectangular in shape. For example, a 24 inch by 36 inch poster is divided into 2 by 3 image sections or partitions to be printed. The image sections or partitions are printed separately on individual sheets of paper, and assembled together by the user to form a large format poster.

In addition, it can be appreciated that important portions of a large image can end up on a joint area where two partitions are joined together when the printout or poster is assembled, thus focusing the viewer's attention on the joint rather than the image.

### OBJECTS AND SUMMARY

In accordance with an exemplary embodiment, it would be desirable to be able to arrange an image of a large complex object so that specified portions are not located at a joint area where two partitions are joined together.

In accordance with an exemplary embodiment, a printing system, comprises: a printer; a client computer having executable instructions for creating a print job for producing a large format of an image, comprising: selecting a medium size; displaying an image on a display associated with the client computer, wherein the image is partitioned into a plurality of images; selecting a partition within the plurality of images; printing the selected partition; and wherein the printer and client computer are connected.

In accordance with another exemplary embodiment, a method of producing a print job for a large format printout of an image, comprises: selecting a medium size; displaying an image on a display, wherein the image is partitioned into a plurality of images; selecting a partition within the plurality of images; and printing the selected partition.

In accordance with a further exemplary embodiment, a computer readable medium containing a computer program for creating a print job, wherein the computer program comprises executable instructions for: selecting a medium size; displaying an image on a display associated with a client computer, wherein the image is partitioned into a plurality of images; selecting a partition within the plurality of images; and printing the selected partition.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram of a network printing system for creating a print job for printing a large format printout of an image in accordance with an exemplary embodiment;

FIG. 2 is an illustration of a driver user interface associated with a client computer in accordance with an exemplary embodiment;

FIGS. 3A and 3B are illustrations of an interactive preview bitmap in accordance with an exemplary embodiment;

FIG. 4 is a flow chart illustrating a method in accordance with an exemplary embodiment; and

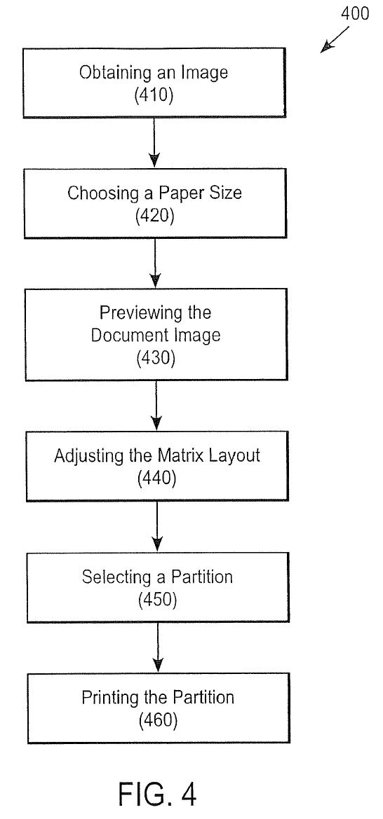

FIG. 5 is a flow chart illustrating a computer readable medium containing a computer program for creating a print job for printing a large format printout of an image in accordance with another exemplary embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, an improved poster printing method according to embodiments of the present invention for splitting banners and/or large image printing (i.e., poster printing) into multiple supported paper size without enlarging and/or resizing the image is disclosed. In accordance with an exemplary embodiment, the method includes selecting a medium having a defined sheet size, dividing the image into a plurality of images (or image partitions) having a smallest number of the selected sheets of the medium, and arranging the image within the plurality of images or image partitions.

It can be appreciated that large image printing includes in most cases images having a size equal to or greater than a defined paper and/or medium size and wherein at least one or more sheets of paper and/or medium are needed. However, it can be appreciated that in accordance with an exemplary embodiment, the image can be equal to or less than the defined paper and/or medium size, and the user wishes to print the image onto one or more sheets of paper and/or medium.

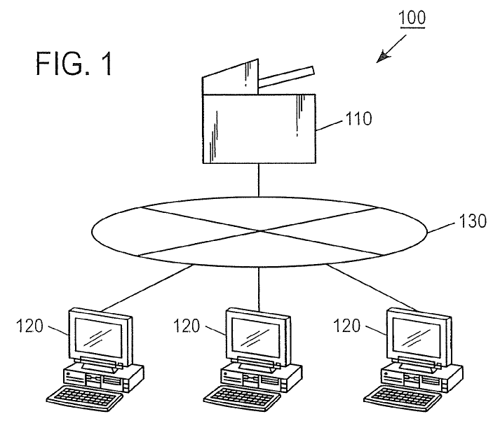

FIG. 1 is a diagram of a network printing system 100 for printing a large format printout of an image in accordance with an exemplary embodiment. As shown in FIG. 1, the system includes a printer 110 and a client computer 120, which are connected to each other via a network 130 (e.g., LAN or WAN). In accordance with an exemplary embodiment, the client computer 120 includes executable instructions for creating a print job for producing a printout of a large image divided into a plurality of pages (or images). The printer 110 receives the print job from the client computer 120 and interprets the print job to develop printable bitmap images of the plurality of images (or pages), which are then printed.

Examples of the network 130 consistent with embodiments of the invention include, but are not limited to, an internet, an intranet, a local area network (LAN) and a wide area network (WAN). The printer 110 and the client computer 120 can be connected with a wire or be connected with wireless by using radio frequency (RF) and/or infrared (IR) transmission.

In accordance with an exemplary embodiment, the client computer 120 includes an operating system software (OS), an application software and a printer driver software. The printer driver software controls the printer 110 connected with the client computer 120 in which the printer driver software is installed. In certain embodiments, the printer driver software produces a print job based on an image and/or document data. In certain embodiments, the printer driver software can control transmission of the print job from the client computer 120 to the printer 110.

In accordance with an exemplary embodiment, the client computer 120 produces the print job based on the image and/or the document data and sends the print job to the printer 110. Users of the client computer 120 can produce the image and/or create the print job, which is sent to the printer via the network 130. Examples of the client computer 120 consistent with certain embodiments of the invention include, but are not limited to, a personal computer (or PC) and a personal digital assistance (PDA). The client computer 120 preferably includes a processing unit, a storing unit, a display unit, an input unit and a transmit unit.

It can be appreciated that in accordance with an exemplary embodiment, the processing unit of the client computer 120 controls the entire client computer and/or the various units in the client computer. The processing unit can run various software including the OS, the application software and the printer driver software. In accordance with an exemplary embodiment, the processing unit produces a print job based on the image and/or document data using the printer driver software. Examples of the processing unit consistent with certain embodiments of the invention include, but are not limited to, a central processing unit (CPU) or a micro processing unit (MPU) with a memory and a software necessary for the processing.

Examples of printers 110 consistent with exemplary embodiments of the invention include, but are not limited to, a laser beam printer (LBP), a multi function laser beam printer including copy function (MFP), an ink jet printer (IJP), a thermal printer (e.g., a dye sublimation printer) and a silver halide printer. The printer 110 can be a color printer or a black and white (B/W) printer. In accordance with an exemplary embodiment, the printer 110 includes a processing unit, a print unit, and a transmit unit.

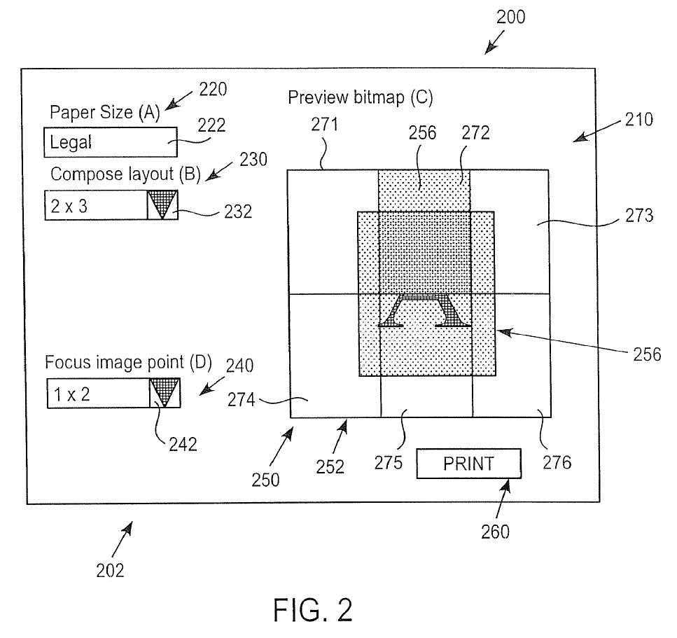

FIG. 2 is an illustration of a driver user interface 200 on a client computer 202 in accordance with an exemplary embodiment. As shown in FIG. 2, the driver user interface 200 includes a graphical user interface screen (or driver user interface) 210 having a paper size window 220, a compose layout window 230, an image focal point window 240, a display 250 in the form of a preview bitmap 252, and a print button 260. In accordance with an exemplary embodiment, the paper size window 220, the compose layout window 230, the image focal point window 240, and the print button 260 are preferably controlled through the use of a cursor via a mouse and/or keyboard. In accordance with an alternative embodiment, the paper size window 220, the compose layout window (or composition layout window) 230, the image focal point window 240, and the print button 260 can be controlled via touch screen technology, which can detect the presence and location of a touch within the display area to change the paper size, change the layout of the image, and to initiate and/or start the printing process.

In accordance with an exemplary embodiment, when a large document image (or poster image) is submitted and opened in an application, the process can be initiated by software as a part of a printer driver or a part of an application program that handles images. The driver user interface 210 displays at least one paper size option within the paper size window 220, a compose layout window 230 in form of a matrix, which indicates how the image partitions will print according to the paper size in the preview bitmap of the image, and an image focal point window 240, which is used to select which of the image partitions 256 will printout. In accordance with an exemplary embodiment, the preview bitmap 252 displays a plurality of small rectangular partitions, which illustrate how the large print image is partitioned upon a selection of a particular paper size. For example, as shown in FIG. 2, if a paper size chosen to be Legal size, the compose layout 230 would be a 2×3 matrix. Alternatively, if a small size sheet of paper (or medium) is selected, the compose layout 230 can be a different matrix, such as a 3×3 matrix (not shown).

In accordance with an exemplary embodiment, the compose layout window 230 has a set of layouts matrixes 232, such as 1×1, 1×2, 1×3, 2×1, 2×2, 2×3, using a roll down cursor window. It can be appreciated that in accordance with an exemplary embodiment, the compose layout 232 is dependent on the paper size chosen and the image provided. It can be appreciated that the compose layout 232 is preferably set or based on the paper size selected, however, it can be appreciated that in accordance with an alternative embodiment, the compose layout 232 selected can dictate the paper size.

In accordance with an exemplary embodiment, the image focal point window 242 is used to select, which of the partitions or image partitions 256 will be used in the printout. For example, as shown in FIG. 2, the compose layout window 232 has a compose layout (or matrix) 230 of 2×3, and an image focal point 242 of 1×2, which corresponds with the partition 256 in the first row, second column of a 2×3 matrix. It can be appreciated that the image focal point has a set of value constraints based on the chosen compose layout 232 (and/or paper size 222). For example, in the case as shown in FIG. 2 having a compose layout of 2×3, the value of the print output index can consist of the following partitions, which are identified in the focus image point window 240 as follows: 1×1 (271); 1×2 (272); 1×3 (273); 2×1 (274); 2×2 (275); and 2×3 (276). It can be appreciated that by changing the compose layout 232, the number of partitions will vary according to the selected matrix, such that the appearance of the selected partitions 256 can be chosen by the user to focus on a certain portion of the larger image. In addition, by changing the compose layout 232, joint areas where two partitions are joined together can be avoided when the printout or poster is assembled.

It can be appreciated that the system and method does not resize the image (i.e., no enlargement or reduction in size, which would reduce or expand the resolution of the original image), which preserves the resolution of the original image. In accordance with an embodiment, only the finally determined output section of the partition is printed as an output (or printed output). It can be appreciated that the final printed output will be determined by the image focal point setting (and/or partition image) 240, and therefore portions of the original image (or document image) can be deleted or omitted from the printed output. The system and method provides the user with the ability to choose the partitions of the image in which he or she wishes to print. In addition, the user has the ability to change the paper size 222 and/or the compose layout 232 to obtain a desired partitions and the corresponding image and/or portion of the larger image or document.

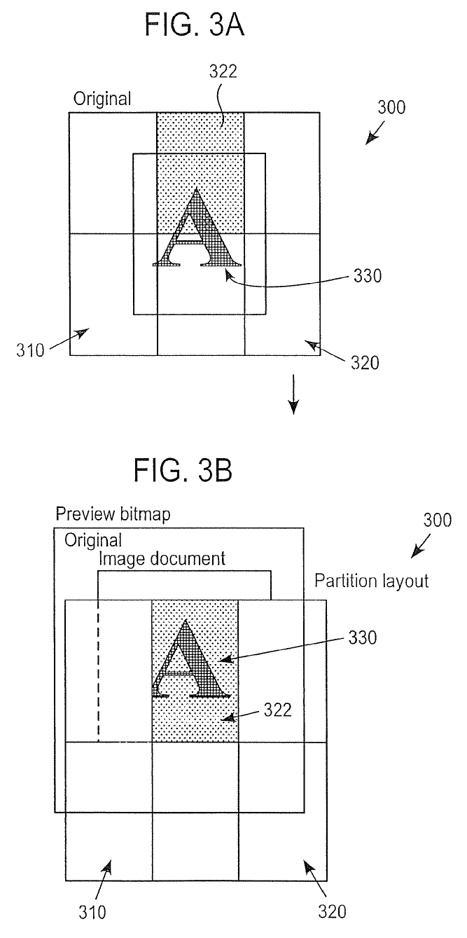

In accordance with another embodiment, the system includes an interactive preview bitmap 300, which allows the user to focus and center a selected partition 322 within the interactive bitmap 300. In accordance with an exemplary embodiment, the original compose layout 310 is moveable within the bitmap 300 using a cursor and/or keyboard stroke (or keyboard strokes). As shown in FIG. 3A, the interactive bitmap 300 includes an original compose layout 310 having plurality of partitions 320. Using a cursor and/or keyboard stoke (or strokes) the original compose layout 310 is moveable (i.e., downward as shown in FIG. 3B) within the interactive bitmap 300 until a desired image 330 (i.e., the letter A) is focused and/or centered within a partition 322. It can be appreciated that in an alternative embodiment, the user can adjust the preview bitmap 300 until the desired image 330 falls into one or more partitions 320. The selected partition 322 (or one or more partitions 320) is then selected from the focus image point window 240 for printing.

A method of producing a print job for an image of a large complex object, which can be focused on a specified object or image, and arranged for printing onto a specified paper or sheet size is disclosed. In accordance with an exemplary embodiment, the method includes the steps of opening or obtaining an image (or document image) on an application (Step 410). In accordance with an exemplary embodiment, the system application is implemented by a software program as a part of the printer driver or a part of an application program that handles images. Within the user interface, a paper size is chosen (e.g. legal size) (Step 420). In accordance with an exemplary embodiment, the system includes a compose layout option having a default value, such as 2×3 matrix. The image (or document image) is previewed in a preview bitmap to view how the print output will appear (Step 430). After previewing the image within the bitmap, the user can adjust the interactive preview bitmap 300 as shown in FIGS. 3A and 3B until a desired image (or portion of the larger image) falls within one or more partitions (Step 440).

The user and/or customer then select a partition (and/or partitions) within the image on the preview bitmap using the image focal point window and selecting the desired image matrix (e.g., 1×2) (Step 450). The selected partition and/or partitions are then sent to the printer as a print job. The printer receives the print job and interprets the print job to develop printable bitmap images of the images (or pages), and the image and/or images are printed as a final output (Step 460).

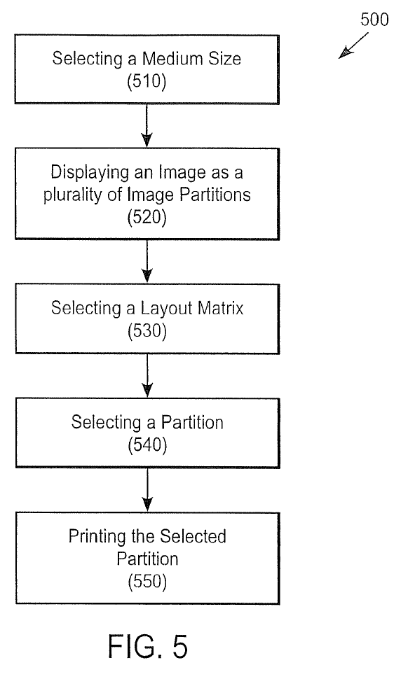

A computer readable medium 500 containing a computer program for creating a print job for printing a large format printout of an image, wherein the computer program comprises executable instructions is disclosed. As shown in FIG. 5, the computer program comprises executable instructions for: selecting a medium size (Step 510); displaying an image on a display, wherein the image is partitioned into a plurality of images (or image partitions) (Step 520); selecting a layout matrix for partitioning the image into a plurality of images (Step 530); selecting a partition within the plurality of images (Step 540); and printing the selected partition (Step 550). It can be appreciated that in accordance with an exemplary embodiment to assist the user in selecting a layout matrix and/or paper size, the user can adjust the interactive preview bitmap as shown in FIGS. 3A and 3B until the desired image falls into a certain captured partition and/or partitions.

In accordance with an exemplary embodiment, the method and system includes a driver user interface application having a large document image, which is submitted and opened to an application. It can be appreciated that methods may be implemented by software as a part of a printer driver or a part of an application program that handles images. In accordance with an exemplary embodiment, when the system and/or method receives a command to image and/or print a large format printout, the software obtains the size of the image and calculates the required sheets of paper needed for a particular paper size. The system and/or method will preferably obtain a best fit by determining the overall height and width of the image and the number of sheets of the selected medium or paper needed. The number of sheets of the selected medium or paper is then used to generate at least one matrix, which will fit the image. The overall size of the large format printout or poster will be determined by multiplying the height and width of each sheet by the number of sheets in each row and column.

Once the matrix has been selected and an overall height and width of the printout has been obtained, in accordance with an exemplary embodiment, the repositioned partition (and/or image) can be centered within the plurality of images by subtracting the height and width of the image from the overall height and width of the printout (i.e., selected matrix). The difference between the height and width of the printout and the image provides an available margin for the top and bottom portions, and the right and left edges, respectively. The available margins (i.e., top and bottom margin, and right and left edge margin) are then divided by two (2) to position the partition within the center of the plurality of images.

In accordance with an exemplary embodiment, a center point of the plurality of images can be obtained by dividing the overall height and width of the printout by two (2) to obtain the x, y coordinates of the center point. Using these coordinates (x, y), the selected partition can be repositioned and/or moved to any desired location within the plurality of images by adding to or subtracting from the coordinates of the center point to move up (addition) or down (subtraction), or to the left (subtraction) or right (addition).

In accordance with an exemplary embodiment, based on the image size and height and width of each sheet of the medium a best fit is calculated based on the smallest (or fewest) number of sheets of the selected medium needed to center the image. It can be appreciated that if a margin is needed on each sheet of the medium to transport the medium through the printing unit, the software program will account for the necessary margins during the calculation of the number of sheets of the selected medium and the matrix thereof.

The invention is directed to both the method and an apparatus, such as a printer or computer, which implements the method by executing a program stored in a non-volatile memory, such as a read only memory (ROM). The method may be introduced into the apparatus by updating the firmware in the non-volatile memory. In this regard, the method may be brought to the apparatus in a form of a package of install software and the firmware, which may be divided and/or compressed so that the install software effectively installs the firmware. The package may be steadily stored in a computer readable diskette, such as a compact disk, or may be transmitted through a wire/wireless communication line.

Additional features may be provided in the poster printing function of the printer driver or application program. For example, the software may allow the user to selectively print individual sheets of a poster. This is convenient for the user because in the printing and assembling process of a poster, sometimes one or more individual sheets may be destroyed due to user error. It will be wasteful to re-print all sheets of the entire poster. Thus, the software provides user an option to only print sheets that contain selected image sections with appropriate overprinting portions. In accordance with an embodiment, a driver user interface such as a poster print preview or bitmap allows the user to easily select the image sections or sheets to be re-printed.

In accordance with another exemplary embodiment, a positioning index can be printed on each sheet to assist in the assembling process. It can be appreciated that sometimes it may be difficult for the user to determine, which printed sheet should be placed at which position when assembling the poster. A small positioning index, such as a pair of column and row numbers, may be printed in the overprinted area of each sheet, such as near a corner, to help the user identify the sheet during assembly. The position index should be printed in an area that will either be torn off or in an area that will be covered by a neighboring sheet.

The method described above can be used to print on paper or other suitable printing medium such as thin plastic sheets, etc. The computer readable medium, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if embodiment of the present invention is combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A printing system, comprising:
a printer;
a client computer having executable instructions for creating a print job for producing a large format of an image, comprising:
selecting a medium size;
displaying an image on a display associated with the client computer, wherein the image is partitioned into a plurality of images;
selecting a partition within the plurality of images;
printing the selected partition; and
wherein the printer and client computer are connected.

2. The system of claim 1, further comprising selecting a layout matrix for partitioning the image into a plurality of images.

3. The system of claim 1, wherein the printer receives the print job from the client computer and develops printable bitmap images of the selected partition and prints the selected partition.

4. The system of claim 1, further comprising an interactive display, wherein the plurality of images are moveable within the display to focus and/or center a portion of the image within at least one partition.

5. The system of claim 1, wherein the display is a user interface.

6. The system of claim 5, wherein the user interface includes a paper size window, a compose layout window, a focus image point window, and a preview bitmap.

7. The system of claim 1, wherein the client computer and printer are connected via a network.

8. A method of producing a print job for a large format printout of an image, comprising:
selecting a medium size;
displaying an image on a display, wherein the image is partitioned into a plurality of images;
selecting a partition within the plurality of images; and
printing the selected partition.

9. The method of claim 8, further comprising selecting a layout matrix for partitioning the image into a plurality of images.

10. The method of claim 8, further comprising sending the print job from a client computer to a printer, wherein the printer receives the print job and interprets the print job to develop printable bitmap images of the selected partition.

11. The method of claim 10, further comprising connecting the client computer to the printer via a network.

12. The method of claim 8, further comprising an interactive display, wherein the plurality of images are moveable within the display to focus and/or center a portion of the image within at least one partition.

13. A computer readable medium containing a computer program for creating a print job, wherein the computer program comprises executable instructions for:
selecting a medium size;
displaying an image on a display associated with a client computer, wherein the image is partitioned into a plurality of images;
selecting a partition within the plurality of images; and printing the selected partition.

14. The computer readable medium of claim 13, further comprising selecting a layout matrix for partitioning the image into a plurality of images.

15. The computer readable medium of claim 13, further comprising sending the print job from a client computer to a printer, wherein the printer receives the print job and interprets the print job to develop printable bitmap images of the selected partition.

16. The computer readable medium of claim 13, further comprising an interactive display, wherein the plurality of images are moveable within the display to focus and/or center a portion of the image within at least one partition.
